(19) United States
(12) Patent Application Publication
(10) Pub. No.: US 2024/0031336 A1
(43) Pub. Date: Jan. 25, 2024

(54) VIRTUAL PRIVATE NETWORK ENHANCEMENT USING MULTIPLE CORES

(71) Applicant: VMWARE, INC., Palo Alto, CA (US)

(72) Inventors: GAURAV JINDAL, Pune (IN); Hussaina Begum Nandyala, Pune (IN)

(21) Appl. No.: 17/975,608

(22) Filed: Oct. 28, 2022

(30) Foreign Application Priority Data
Jul. 21, 2022 (IN) 202241041810

(51) Int. Cl. H04L 9/40

(52) U.S. Cl. CPC H04L 63/0272; H04L 63/061; H04L 63/0428; H04L 63/029

(57) ABSTRACT

Embodiments described herein relate to load balancing using multiple CPUs. A method for tunnel creation according to a security protocol at a source tunnel endpoint (TEP) includes exchanging messages with a destination TEP to create a security association (SA) for the tunnel creation; sending a message to the destination TEP, wherein the message is an encrypted message based on the first message exchange, and the message includes a traffic selector of the source TEP and a number of available CPUs of the source TEP; receiving a message from the destination TEP, wherein the message is an encrypted message based on the first message exchange, and the message includes a traffic selector of the destination TEP and a number of available CPUs of the destination TEP; and determining a number of SAs to create with the destination TEP, wherein the determination is based on the traffic selectors and the number of available CPUs.

### RELATED APPLICATIONS

Benefit is claimed under 35 U.S.C. 119(a)-(d) to Foreign Application Serial No. 202241041810 filed in India entitled “VIRTUAL PRIVATE NETWORK ENHANCEMENT USING MULTIPLE CORES”, on Jul. 21, 2022, by VMware, Inc., which is herein incorporated in its entirety by reference for all purposes.

### BACKGROUND

Internet Protocol (IP) security (IPsec) protocols are widely used to protect packets communicated between endpoints against unauthorized access and corruption or manipulation using data encryption technologies. Endpoints communicating across an IPsec connection are referred to as IPsec peers. In accordance with IPsec protocols, security associations (SAs) are established between the endpoints. These SAs may be established between the endpoints by an Internet key exchange (IKE) module at each endpoint that manages and configures the encryption. Each SA specifies security attributes for a one-way or simplex connection. Therefore, at least two SAs—one for each direction—are established between two IPsec peers. Each SA is a form of contract between the endpoints detailing how to exchange and protect information communicated between each other. Each SA may be comprised of a mutually agreed-upon key, one or more security protocols, and/or a security parameter index (SPI) value. After SAs have been established between two endpoints, an IPsec protocol may be used to protect data packets for transmission between the IPsec peers.

In an Encapsulating Security Payload (ESP) tunnel mode, tunnel endpoints (TEPs) are used for applying IPsec protocols to encrypt and encapsulate egress packets from a source endpoint and to decrypt and decapsulate ingress packets for a destination endpoint in order to secure communication between the endpoints. For example, a source endpoint may generate and forward egress IP packets to a source TEP associated with the source endpoint. In particular, the source endpoint may generate an IP packet including a header with the IP address of the source endpoint set as the source IP address and the IP address of the destination endpoint set as the destination IP address. A medium access control (MAC) address of the source TEP may further be set as a next-hop MAC address of the IP packet in the header.

The source TEP receives the IP packet and encrypts the original IP packet including the header of the original IP packet based on a SA established between the source TEP and the destination TEP. For example, the source TEP encrypts the original IP packet with a mutually agreed-upon key of the SA. The source TEP further encapsulates the encrypted packet by adding a new IP header and an ESP header to the encrypted packet, including an SPI value corresponding to the SA used to encrypt the packet, to generate an encapsulated ESP encrypted data packet. The new IP header includes a source IP address of the source TEP and a destination IP address of the destination TEP. The new IP header is used to forward the encapsulated ESP encrypted data packet through a network from the source TEP to the destination TEP.

The destination TEP may then decapsulate and decrypt the encapsulated ESP encrypted data packet to extract the original IP packet. For example, the destination TEP may identify the SA corresponding to the IPsec tunnel connection to decrypt the encapsulated ESP encrypted data packet based on the SPI value included in the ESP header. Based on the destination IP address in the header of the original IP packet, the destination TEP forwards the original IP packet to the destination endpoint.

IPsec protocols may be deployed in virtualized computing instances (VCIs), such as a virtual machine (VM) or a container, to gain the benefits of virtualization and network functions virtualization (NFV). For example, VCIs may be configured to serve as TEPs. However, use of such IPsec protocols by VCIs may cause certain other features at the VCIs to function improperly.

In a virtualized environment, virtual network interface controllers (VNICs) are instantiated in a virtualization layer (also referred to herein as the “hypervisor”) supporting VCIs. VNICs are programmed to behave similarly to physical NICs (PNICs). Both PNICs and VNICs may support receive side scaling (RSS), which involves computing a hash of incoming packet header attributes and, based on the computed hash values, distributing the incoming network traffic across central processing units (CPUs) for processing. Packets belonging to the same connection are distributed to the same RSS queue, based on the computed hash value, for processing by a particular CPU. For a VNIC, packets are distributed to virtual RSS queues associated with the VNIC based on the computed hash value. The packets in a virtual RSS queue are processed by a particular virtual CPU associated with the virtual RSS queue.

Traditionally, for a VNIC, RSS is performed for IP packets based on a detected packet type indicated by an IP protocol number in an IP header of the packet that indicates the next higher layer protocol being carried as the IP payload. For example, the VNIC may be configured to perform RSS only for packets of type TCP (transmission control protocol) and UDP (user datagram protocol), corresponding to IP protocol numbers 6 and 17, respectively. However, for packets encapsulated using ESP tunnel mode, the IP protocol number in the new IP header may be 50. Accordingly, the VNIC may not be configured to perform RSS for received encapsulated ESP encrypted data packets based on related information.

Further, the hash computed for selecting a RSS queue is traditionally computed based on the source IP address and destination IP address in the header of the packet. In an encapsulated ESP encrypted data packet, the only available (i.e., non-encrypted) IP addresses for computing the hash are the source IP address of the source TEP and the destination IP address of the destination TEP. Accordingly, at a VNIC of a destination TEP, all encapsulated ESP encrypted data packets received from the same source TEP, regardless of the source endpoint that sent the packet and the destination endpoint, would be assigned to the same virtual RSS queue. Accordingly, in a scenario where there is only one or a few source TEPs, meaning there is only one or a few tunnels, it is unlikely that RSS could be used to distribute ingress processing of encapsulated ESP encrypted data packets in a balanced manner. For example, unless there is a very large number (e.g., thousands) of IPsec tunnels or many different SAs, it is very unlikely that the RSS performed by the VNIC results in a statistically uniform, or near-uniform, distribution of packets to virtual CPUs.

One solution to deterministic load balancing of processing encapsulated encrypted data packets at a destination tunnel endpoint is described in U.S. Pat. No. 11,336,629, the entire contents of which are hereby incorporated by reference herein. Based on the solution described in this patent, different cores are explicitly allocated for SPI's that can be used in the case when multiple SAs are negotiated. A destination TEP may be configured with an ESP RSS mode to assign each incoming packet, received from a certain source endpoint, to a certain RSS queue based on an identifier that is encoded in an SPI value included the packet. The identifier may identify an RSS queue number associated with an RSS queue associated with a certain virtual CPU at the destination TEP. Accordingly, when received by the destination TEP, an incoming encapsulated ESP encrypted packet is examined by the destination TEP to determine which RSS queue the packet should be assigned to based on the identifier in the SPI value. The selection of an identifier is based on a selection of a virtual CPU to help ensure that incoming network traffic from different source endpoints, through the source TEP, is evenly distributed among virtual CPUs at the destination TEP.

However, the solution described in the aforementioned patent application may not address the use of a single core and limited throughput in all cases. One examples is a virtual private networking (VPN) session with a single pair of IKE and IPsec SAs.

For policy-based VPN, an IPsec VPN tunnel created between two endpoints is specified within the policy itself with a policy action for traffic that meets the policy's match criteria. A policy statement refers to the VPN by name and creates an IPsec SA to specify the traffic that is allowed access to the IPsec VPN tunnel. For example, if a policy contains a set of source addresses and destination addresses, whenever one of the users belonging to the address set attempts to communicate with any one of the hosts specified as the destination address, a new IPsec VPN tunnel is negotiated and established. Because each IPsec VPN tunnel requires its own negotiation process and separate pair of SAs, the use of policy-based IPsec VPNs can be more resource-intensive than route-based VPNs. A policy-based VPN session may be configured with a single source and destination subnet (e.g., a single classless inter-domain routing (CIDR) value) resulting in use of a single core at both peer sides for encryption and decryption.

A route-based VPN is a configuration in which an IPsec VPN tunnel created between two endpoints is referenced by a route that determines which traffic is sent through the tunnel based on a destination IP address. The traffic may be routed over a virtual tunnel interface (VTI). With route-based VPNs, multiple security policies may be configured to regulate traffic flowing through a single VPN tunnel between two sites, and, as in the case of policy-based VPNs, there is just one set of IKE and IPsec SAs. Unlike policy-based VPNs, for route-based VPNs, a policy refers to a destination address, not a VPN tunnel. That is, the regulation of traffic is not based on the delivery means (i.e., the tunnel), instead, the policies are based on the destination of the traffic. In one example, a route-based VPN may use a border-gateway protocol (BGP). The route-based VPN may be configured with a single CIDR route, with a single source and destination subnet, resulting in use of only a single core at both peer sides for encryption and decryption, although additional cores may be available at the source and/or destination.

In addition, when the underlying resources for the VPN, such as the number of cores at the peer devices, are not known and/or are not shared during initial IKE exchanges the cores may not be deterministically load balanced. Further, in some cases a user may configure a VPN session with a limited configuration that does not utilize all of the available cores.

Accordingly, the VPN throughout may be limited by underutilization of available processing cores.

### SUMMARY

Herein described are one or more embodiments of a method for tunnel creation according to a security protocol at a source TEP. The method includes exchanging first messages with a destination TEP to create a first SA for the tunnel creation. A second message is sent to the destination TEP. The second message is an encrypted message based on the first message exchange, and includes a traffic selector of the source TEP and a first number of available CPUs of the source TEP. A third message is received from the destination TEP. The third message is an encrypted message based on the first message exchange, and includes a second traffic selector of the destination TEP and a second number of available CPUs of the destination TEP. A number of second SAs to create is determined, wherein the determination is based on the first traffic selector, the second traffic selector, and a larger of the first number of available CPUs and the second number of available CPUs.

Also described herein are embodiments of a computer system including a memory comprising executable instructions and a processor in data communication with the memory and configured to execute the instructions to cause the computer system to perform a method described above for tunnel creation according to a security protocol.

Also described herein are embodiments of a non-transitory computer readable medium comprising instructions to be executed in a computer system, wherein the instructions when executed in the computer system perform the method described above for tunnel creation according to a security protocol.

### BRIEF DESCRIPTION OF THE DRAWINGS

FIG. 1 illustrates an example of a networking environment, in accordance with some embodiments.

FIG. 2 illustrates an example block diagram of host machine for use in a virtualized network environment, according to some embodiments.

FIG. 3 illustrates example operations for use by a destination tunnel endpoint for establishing an IPsec tunnel with an IPsec peer, according to some embodiments.

FIG. 4 illustrates an example SPI value including an identifier and a remainder, according to some embodiments.

FIG. 5 illustrates an example call flow for a two-phase IKE exchange, according to some embodiments.

FIG. 6A illustrates an example SA table for a local IPsec edge, according to some embodiments.

FIG. 6B illustrates an example SA table for a peer IPsec edge, according to some embodiments.

FIG. 7A illustrates an example route advertisement table for a gateway, according to some embodiments.

FIG. 7B illustrates an example route advertisement table for a peer gateway, according to some embodiments.

### DETAILED DESCRIPTION

In some cases, VNICs may be configured to perform RSS for received encapsulated ESP encrypted data packets. For example, the destination tunnel endpoint's VNIC may be configured to compute a hash of incoming packet header attributes, including an SPI value associated with each packet, and distribute the incoming network traffic across CPUs for processing based on the computed hash values. However, even in such cases, unless there is a very large number (e.g., thousands) of IPsec tunnels such that there are many different combinations of source and destination tunnel endpoint IP addresses, or many different SAs such that there are many different SPI values in cases where there is a single IPsec tunnel, it is very unlikely that the RSS performed by the VNIC results in a substantially uniform distribution of packets to virtual CPUs.

Certain embodiments described herein relate to configuring a destination TEP with an ESP RSS mode to assign each packet incoming to the destination TEP, received from a certain source endpoint, to a certain RSS queue based on an identifier that is encoded in an SPI value included the packet. As described below, the identifier may be indicated by a certain number of bits in the SPI values. The identifier may identify an RSS queue number associated with an RSS queue associated with a certain virtual CPU at the destination TEP. When received by the destination TEP, an incoming encapsulated ESP encrypted packet is examined by the destination TEP to determine which RSS queue the packet should be assigned to based on the identifier in the SPI value. The identifier may be encoded in the SPI value during IPsec tunnel creation performed by the destination and source TEPs. The selection of an identifier is based on a selection of a virtual CPU. A virtual CPU is selected by the destination TEP from the plurality of virtual CPUs based on a CPU selection function. One of a variety of CPU selection functions may be used to help ensure that incoming network traffic from different source endpoints, through the source TEP, is distributed among virtual CPUs at the destination TEP.

As described above, however, when only a single SA is configured, such as when a single source and destination subnet are configured, there is only one SPI and, therefore, deterministic load balancing may be limited.

Accordingly, embodiments presented herein relate to systems and methods for VPN enhancement using multiple cores. The embodiments described herein may enable a maximum number of cores available for VPN datapath processing to be used. For example, the embodiments described herein may result in a greater number of IPsec SAs being created, independent of a static user configuration.

According to certain embodiments, IKE exchanges may include sharing a number of available cores at the initiator and a number of available cores at the responder as part of the initial exchanges. In some embodiments, the peer side number of available cores can be considered in determining a number of IPsec SAs to establish to distribute IPsec connections across the cores and provide improved throughput for the VPN datapath processing. In some embodiments, the system determines a number of IPsec SAs, on-demand, instead of using only one core in the case that the user may have configured only one source subnet and one destination subnet for the VPN session. According to certain embodiments, a number of SAs to create is determined based on the larger of the supported number of available cores at the initiator and responder sides. In some embodiments, a source subnet and destination subnet are divided into a number of IP address ranges corresponding to the number of SAs to be created.

Accordingly, in a policy-based VPN, the local and peer edges may each maintain a SA table that maps SAs, initiator and responder subnet ranges, initiator and responder SPIs, and initiator and responder cores for the determined maximum number of available cores.

In a route-based VPN, a single VTI or multiple VTIs may be used for the established SAs. In some embodiments, source and destination VTI pairs are associated with the SAs and subnet ranges. Accordingly, in the route-based VPN, route advertisement tables for the local and peer gateways map each advertised route to an IP range, a local VTI, a remote VTI, and an advertisement.

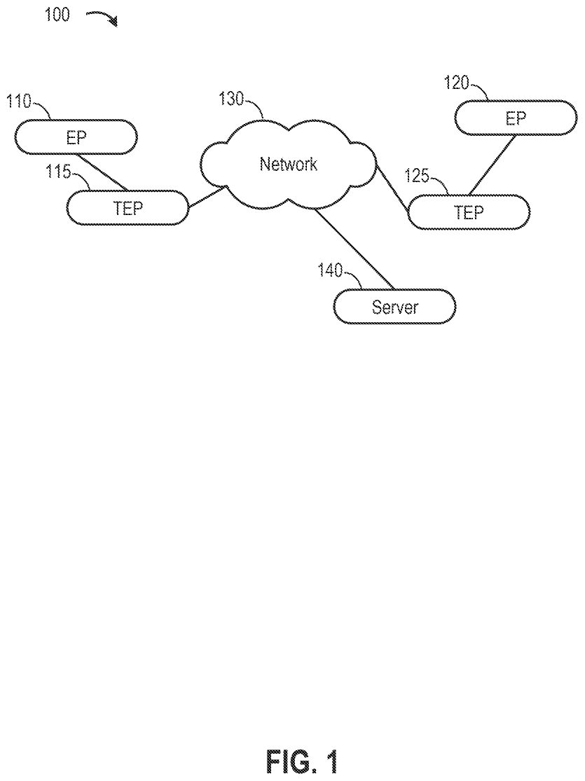

FIG. 1 illustrates an example of a networking environment 100. As shown by FIG. 1, a physical network 130 connects a plurality of TEPs, including TEP 115 and TEP 125, and a server 140. A TEP may be a physical computing device (e.g., physical server, physical host). In certain embodiments, a TEP may be a VCI (e.g., VM, container, data compute node, isolated user space instance, etc.) as further discussed herein.

TEPs 115 and 125 may connect endpoints, including endpoint 110 and endpoint 120, for example, to stretch a network across geographically distant sites. An endpoint refers generally to an originating endpoint (“source endpoint”) or terminating endpoint (“destination endpoint”) of a flow of network packets, which can include one or more data packets passed from the source to the destination endpoint. In practice, an endpoint may be a physical computing device (e.g., physical server, physical host). In certain embodiments, an endpoint may be a VCI (e.g., VM, container, data compute node, isolated user space instance) as further discussed herein.

In networking environment 100, endpoints may communicate with or transmit data packets to other endpoints via TEPs as discussed. Endpoint 110 may transmit a data packet to endpoint 120 in a secured fashion via TEPs 115 and 125, acting as a source TEP and a destination TEP, respectively. TEPs 115 and 125 may implement IPsec protocols, including ESP tunnel mode, to secure communication between one another. In some embodiments, before any data can be securely transferred between endpoints 110 and 120 using the IPsec framework, SAs (e.g., including a mutually agreed-upon key, one or more security protocols, and/or a SPI value) may need to be established between TEPs 115 and 125. In some embodiments, the SAs may be established by TEPs 115 and 125 on behalf of endpoints 110 and 120.

The mutually agreed-upon key (e.g., encryption/decryption key), in some embodiments, is generated by a server (e.g., server 140) and subsequently distributed to TEPs 115 and 125 associated with the endpoints 110 and 120. The one or more security protocols, described above, may be one or more IPsec security protocols such as Authentication Header (AH), Encapsulating Security Payload (ESP), etc. After SAs have been established for the two endpoints 110 and 120, one or more of these security protocols may be used to protect data packets for transmission. Though certain embodiments are described herein with respect to the ESP security protocol, other suitable IPsec security protocols (e.g., AH protocol) alone or in combination with ESP, may be used in accordance with the embodiments described herein. Further, the embodiments described herein may similarly be used for different types of traffic such as IPv4, IPv6, etc. In certain embodiments, the techniques herein can be used to hash ESP packets encapsulated in other packet types (e.g., VXLAN or Geneve).

In addition to a mutually agreed-upon key and security protocol, an SA includes an SPI value. In some embodiments, each SPI value is a binary value associated with an SA, which enables a TEP to distinguish among multiple active SAs. As an example, SPI values may be used to distinguish between the inbound and outbound SAs of different endpoints. In some cases, IKE protocol is used to generate these SPI values and encryption/decryption keys in the IPsec framework. For example, prior to any data exchange, IKE performs a two-phase negotiation session, which results in establishing two SAs between two IPsec peers (e.g., TEPs). These SAs may not only contain mutually agreed-upon encryption and decryption keys to be used for incoming and outgoing traffic, but also help maintain sequence numbers for each data transfer. These sequence numbers are maintained to ensure anti-replay, which prevents hackers from injecting or making changes in data packets that travel from a source to a destination TEP.

In some cases, instead of using IKE, distributed network encryption (DNE) may be utilized to simplify key management, including key generation and exchange, and SPI allocation. DNE provides a central controller, which may run on server 140, that generates and distributes encryption/decryption keys and SPI values for endpoints to TEPs in network environment 100. DNE also simplifies protecting network traffic of TEPs by allowing users (e.g., network administrators) to define simple security rules and key policies. For example, in some embodiments, server 140 may store, in its memory, a plurality of security rules and key policies. Security rules may be user-defined rules that users input into the central unit through an interface (e.g., via a manager, which may be a physical computing device or a VCI supported by a physical computing device). Security rules may define what key policy is used by server 140 to generate an encryption/decryption key for data transfer between TEPs for endpoints in a network. In some embodiments, each key policy may be associated with one or more endpoints and include certain specifications (e.g., one or more of an algorithm, action, strength of the key, etc.) that define properties of an encryption/decryption key.

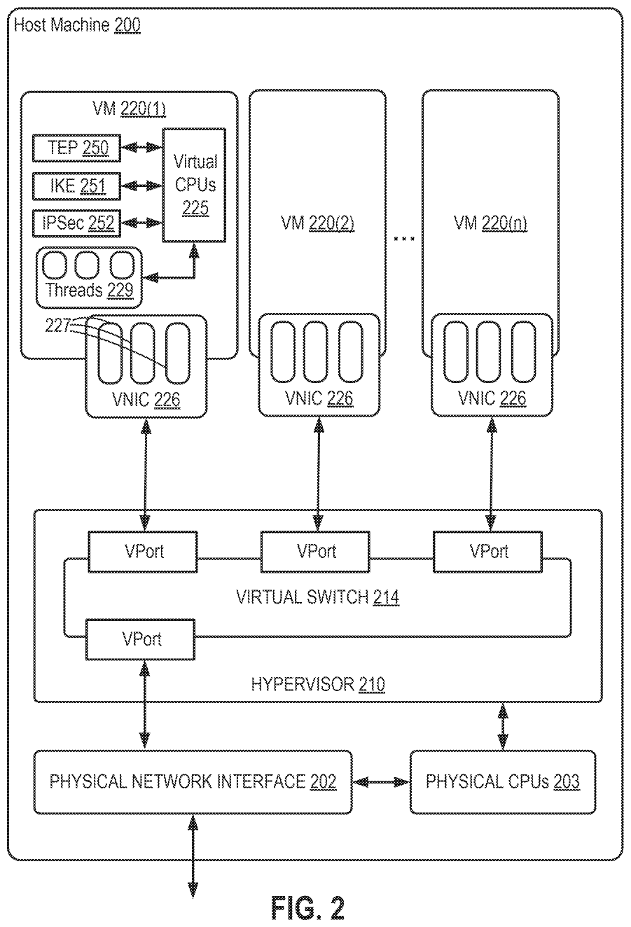

FIG. 2 illustrates an example block diagram of host machine 200 for use in a virtualized network environment, according to some embodiments. As illustrated, host machine 200 includes a physical network interface controller (PNIC) 202, a hypervisor 210, and a plurality of VMs 220(1), 220(2), . . . , 220(n) (referred to collectively herein as VMs 220).

Host machine 200 may provide part of the computing infrastructure in a virtualized computing environment distributed among multiple host machines. Though certain embodiments are described herein with respect to VMs, the same principals and techniques may also apply to other appropriate VCIs (e.g., VM, container, data compute node, isolated user space instance) or physical computing devices. In certain embodiments, host machine 200 is a physical general purpose computer (e.g., a server, workstation, etc.) and includes one or more physical CPUs 203. Although not shown, in addition to physical CPUs 203, host machine 200 may also include a system memory, and non-volatile data storage, in addition to one or more physical network interfaces, such as PNIC 202, for communicating with other hardware computing platforms, entities, or host machines on a physical network accessible through PNIC 202.

Hypervisor 210 serves as an interface between VMs 220 and PNIC 202, as well as other physical resources (including physical CPUs 203) available on host machine 200. Each VM 220 is shown including a virtual network interface card (VNIC) 226, which is responsible for exchanging packets between VM 220 and hypervisor 210. Though shown as included in VMs 220, it should be understood that VNICs 226 may be implemented by code, such as VM monitor (VMM) code, associated with hypervisor 210. VMM code is part of host code that is provided as part of hypervisor 210, meaning that a VNIC 226 is not executed by VM 220's code, also referred to as guest code. VNICs 226 may be, in some cases, a software implementation of a physical network interface card. Each VM 220 is connected to a virtual port (vport) provided by virtual switch 214 through the VM's associated VNIC 226. Virtual switch 214 may serve as physical network switch, i.e., serve as an edge device on the physical network, but implemented in software. Virtual switch 214 is connected to PNIC 202 to allow network traffic to be exchanged between VMs 220 executing on host machine 200 and destinations on an external physical network.

In certain embodiments, each VNIC 226 may be configured to perform RSS. Accordingly, each VNIC 226 may be associated with a plurality of software based VNIC RSS queues 227 on VM 220. Each of the VNIC RSS queues 227 represents a memory space and may be associated with a certain virtual CPU (e.g., a different virtual CPU) from one or more virtual CPUs 225. As described in U.S. Pat. No. 10,255,091, which is incorporated herein by reference, a virtual CPU may correspond to different resources (e.g., physical CPU or execution core, time slots, compute cycles, etc.) of one or more physical CPUs 203 of host machine 200. When receiving incoming packets (e.g., not including encapsulated ESP encrypted packets), VNIC 226 may compute a hash value based on header attributes of the incoming packets and distribute the incoming packets among the VNIC RSS queues 227 associated with VNIC 226. For example, different hash values may be mapped to different VNIC RSS queues 227. Each VM 220 spawns threads 229 that are responsible for accessing incoming packets stored in RSS queues 227 and causing one or more actions (e.g., forwarding, routing, etc.) to be executed by a virtual CPU 225 on the packet.

As an example, a thread 229 may access a packet stored in an RSS queue 227 that corresponds to a certain virtual CPU 225. This certain virtual CPU 225 is then used to execute a variety of actions on the packet. Threads 229 may access the incoming packets either through polling RSS queues 227 or receiving interrupt events. Threads 229 may be configured to handle the incoming packets using a pipeline mode (e.g., multiple threads are each responsible for a different action that is performed on the packet) or a run-to-completion mode (e.g., a single thread is responsible for taking packets, one at a time, from a certain RSS queue 227 and causing a variety of actions to be performed on the packet, from start to finish).

Once a thread 229 that is scheduled on a virtual CPU 225 accesses a packet for processing, the virtual CPU 225 begins running an interrupt handler invoked by the kernel in response to an interrupt issued by VNIC 226. The virtual CPU 225 then continues with further processing the packet by performing protocol processing, unless another virtual CPU is selected, by a higher level packet steering module (e.g., Receive Packet Steering (RPS), a Linux software module that helps prevent one of queues 227 from becoming a bottleneck in network traffic) to handle the protocol processing.

Accordingly, using RSS, no single virtual CPU 225 is loaded with processing all incoming packets for VNIC 226. In addition, the processing of packets is distributed to different virtual CPUs 225 at the VNIC 226 at the beginning of the processing pipeline for the packets, therefore taking advantage of distributed processing of packets at an early stage in the processing pipeline.

In some embodiments, a VM 220 is configured to perform the functions of a TEP. For example, VM 220(1) may be configured with a TEP 250, which is configured to implement IPsec protocols and functionality using an IPsec layer or component 252 (referred to herein as IPsec 252). More specifically, IPsec 252 encrypts outgoing packets destined for a certain destination TEP by encapsulating them with, for example, ESP headers based on a corresponding SA. In each packet's ESP header, IPsec 252 also inserts an SPI value associated with the SA that is generated by the IKE layer or component, referred to herein as IKE 251, through an IKE negotiation performed between IKE 251 and an IKE component of a destination TEP associated with the destination endpoint. IPsec 252 is also configured to decrypt incoming encapsulated ESP encrypted data packets received from a source TEP. IKE 251 is responsible for performing IKE negotiations with IKE components of other network entities to generate encryption/decryption keys and SPI values.

Further, another VM 220 executing on host machine 200, or on another host, may be configured as an endpoint associated with TEP 250. For example, VM 220₂ may be an endpoint associated with TEP 250. Accordingly, in some embodiments, another source endpoint may generate an IP packet to send to VM 220(2). The source endpoint may forward the IP packet to a source TEP, which encrypts and encapsulates the packet using an IPsec protocol to generate an encapsulated ESP encrypted data packet. The source TEP then sends the encapsulated ESP encrypted data packet to destination TEP 250. The encapsulated ESP encrypted data packet is, therefore, received at virtual switch 214 of host machine 200 via PNIC 202. Virtual switch 214 sends the encapsulated ESP encrypted data packet to VNIC 226 of VM 220(1).

As further described above, VNIC s may be configured to perform RSS for received encapsulated ESP encrypted data packets based on the packets' SPI values. For example, VNIC 226 of VM 220(1) receives an encapsulated ESP encrypted data packet, as described above. VNIC 226 then generates (e.g., computes) a hash value (e.g., CPU core ID) based at least in part on an SPI value included in the ESP header of the encapsulated ESP encrypted data packet. For example, VNIC 226 identifies the encapsulated ESP encrypted data packet as an ESP packet based on an IP protocol number in the header of the packet indicating it is an ESP packet (e.g., equal to 50), and therefore calculates the hash value based at least in part on the SPI value.

TEP 250, as a destination TEP, may associate different SAs with different source endpoints. For example, destination TEP 250 may use a first SA for packets sent from a first source endpoint via a source TEP for VM 220(2), and a second SA for packets sent from a second source endpoint via the same source TEP for VM 220(2). Accordingly, even though encapsulated ESP encrypted data packets may be received at destination TEP 250 from the same source TEP and, therefore, have the same source and destination IP addresses in the new header of each of the encapsulated ESP encrypted data packets, different hash values may be calculated for the packets based at least in part on the different SPI values in the different SAs. In some embodiments, the hash value is further computed based on the source and/or destination IP addresses in the new header, such as to add further entropy to the hash value calculation. Subsequently, VNIC 226 assigns the encapsulated ESP encrypted data packet to one of the plurality of VNIC RSS queues 227 based on the generated hash value.

However, as described above, in certain use cases, even if the VNIC is configured to perform RSS for received encapsulated ESP encrypted data packets, e.g., by taking into account the packets' SPI values when computing hash values, it is very unlikely that a relatively uniform distribution of packets to virtual CPUs results from the RSS. For example, VNIC 226 may receive, from a single source TEP, encapsulated ESP encrypted packets with four different SPI values, each associated with a different SA established between a source endpoint in the physical network and a destination endpoint (e.g., VM 220(2)) residing on host machine 200. However, the hash algorithm that is used by VNIC 226 may be configured such that the same hash value may be generated for all or most of the SPI values, which results in all or most of the packets being assigned to the same RSS queue 227. As a result, while hashing the SPI value improves distribution across RSS queues, especially when a relatively large number of IPsec channels are carried by the tunnel, configuring a VNIC 226 to perform RSS for encapsulated ESP encrypted data packets based on the packets' SPI values does not necessarily guarantee a reasonably fair and even distribution of the packets among virtual CPUs 225 unless there is a very large number of IPsec tunnels or many different SAs.

In certain embodiments, a destination TEP is configured with an ESP RSS mode to assign each incoming packet, received from a certain source endpoint through a source TEP, to a certain RSS queue 227 based on an identifier that is encoded in an SPI value included the packet. In some embodiments, the identifier may be indicated by a certain number of bits in the SPI values. The identifier may identify an RSS queue number associated with an RSS queue associated with a certain virtual CPU 225. When received by the destination TEP, an incoming encapsulated ESP encrypted packet is examined by the destination TEP to determine which RSS queue 227 the packet should be assigned to based in part or entirely on the identifier in the SPI value. In some embodiments, the identifier is encoded in the SPI value during IPsec tunnel creation performed by the destination and source TEPs. The selection of an identifier is based on a selection of a virtual CPU 225. A virtual CPU 225 is selected by the destination TEP from the plurality of virtual CPUs based on a CPU selection function. One of a variety of CPU selection functions may be used to help ensure that incoming network traffic from different source endpoints, through the source TEP, is evenly distributed among virtual CPUs 225.

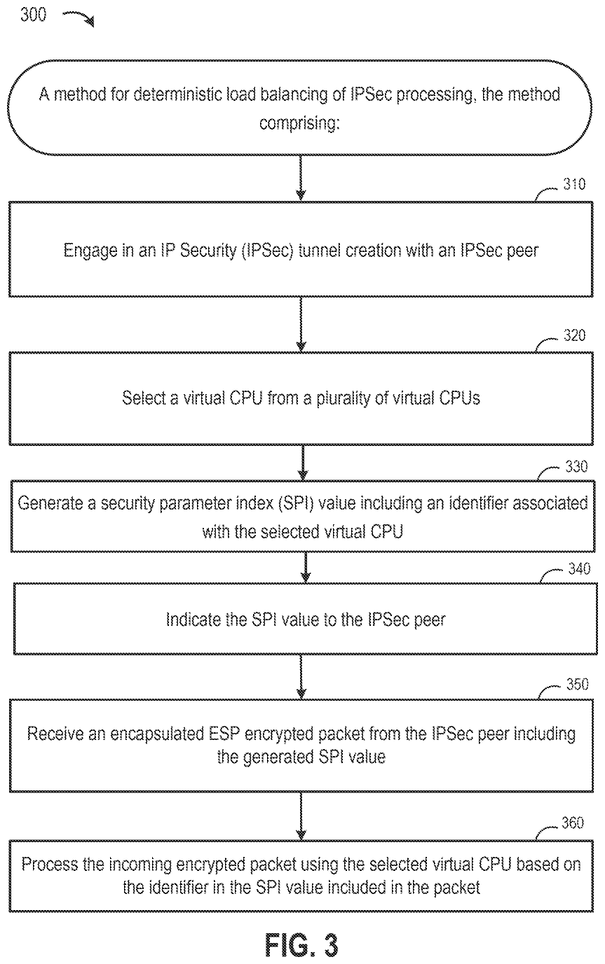

FIG. 3 illustrates example operations 300 for use by a destination TEP to enable deterministic load balancing of IPsec processing, in accordance with some embodiments. In the example of operations 300, the destination TEP is TEP VM 220(1), which is TEP 125 of FIG. 1; the source TEP is TEP 115; the source endpoint is endpoint 110; and the destination endpoint is VM 220(2), which is endpoint 120 of FIG. 1. In other examples, the destination and source TEPs may be physical computing devices. TEP 125 and TEP 115 are also referred to as IPsec peers.

At block 310, the TEP 125 engages in IPsec tunnel creation with a TEP 115. For example, IPsec 252 of TEP VM 22(1) engages in IPsec tunnel creation with an IPsec component (with the same or similar capabilities as IPsec 252) executing on TEP 115. In some embodiments, IPsec tunnel creation may be triggered when network traffic is flagged for protection according to an IPsec security policy configured in the IPsec peers, such as TEP 125 and TEP 115 in the physical network. For example, TEP 115 may receive data packets from endpoint 110 that are flagged for protection and destined for endpoint 120. As a result, the IPsec component residing in TEP 115, engages in IPsec tunnel creation with an IPsec 252 residing in TEP 125 (i.e., TEP VM 220(1)) for any data packets intended to be communicated between endpoint 120 and endpoint 110. Note that IPsec tunnel creation is initiated if SAs are not already established for communication between endpoint 110 and endpoint 120. If SAs are already established for that communication, the IPsec component residing in TEP 115 finds a corresponding outbound SAs and uses it to encrypt the outgoing packet destined for endpoint 120.

Once the tunnel creation starts, the two IPsec peers, TEP 125 and TEP 115, begin the two-phase IKE process, as described above, using their IKE components. For example, during IKE Phase I, IKE 251 residing in TEP 125 and the IKE component of TEP 115 (“the peer IKE component”) communicate to authenticate and establish a secure channel between themselves to enable IKE Phase II. Once a secure channel between the two IKE components is established, during IKE Phase II, IKE 251 and the peer IKE component negotiate and establish two unidirectional IPsec SAs for communication between the endpoint 110 and endpoint 120. As described above, each SA includes a unique SPI value for enabling the IPsec peers to distinguish between SAs. For example, one SA (referred to as an “in-bound SA” in the embodiments described herein) may be established for encrypting data packets transmitted by endpoint 110 and destined for endpoint 120 while another SA (“outbound SA”) may be established for encrypting data packets transmitted by endpoint 120 and destined for endpoint 110.

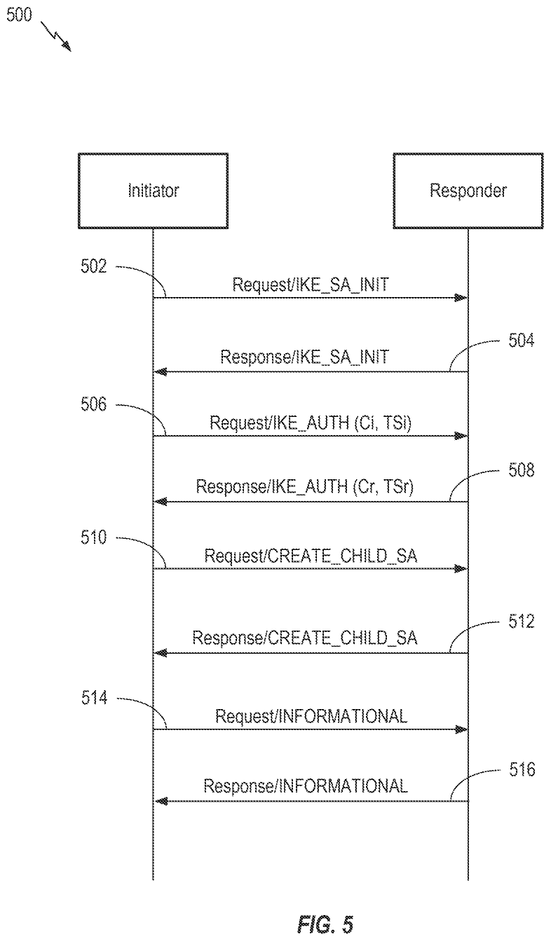

A two-phase IKE process is described in more detail below with respect to FIG. 5. According to embodiments of the present disclosure, the two-phase IKE process includes an exchange or negotiation of a number of available cores at the IPsec peers. Further, according to embodiments of the present disclosure, additional SAs may be established based on the number of available cores at the IPsec peers. In some embodiments, traffic selectors exchanged during the two-phase IKE process may be divided in such a manner as to establish a maximum number of SAs that utilizes the maximum number of available cores at the IPsec peers.

At block 320, the TEP 125 selects a virtual CPU from a plurality of virtual CPUs for processing packets originating from endpoint 110 and received through TEP 115. For example, in some embodiments, IKE 251 selects a virtual CPU from the plurality of virtual CPUs 225 to process all the future incoming encapsulated ESP encrypted packets received from TEP 115 and associated with traffic originated from endpoint 110. The corresponding in-bound SA that is created later, as described further below, is then assigned to the selected virtual CPU 225. When selecting a virtual CPU 225, IKE 251 utilizes a CPU selection function that is configured to enable a more even distribution of the load level being handled by virtual CPUs 225. Note that, in some embodiments, IKE 251 identifies virtual CPUs 225 by their corresponding CPU core IDs. As such, in such embodiments, selecting a virtual CPU 225 refers to a selection of a CPU core ID associated with the virtual CPU 225.

In one example, the CPU selection function comprises a round-robin algorithm for selecting virtual CPUs 225. To illustrate this with an example, TEP 125 may include four virtual CPUs 225. In such an example, the selection process may start by IKE 251 selecting the first virtual CPU, then the second, third, and fourth, and then back to the first virtual CPU, and so on, in a continuous loop. IKE 251 assigns a different in-bound SA to each selected virtual CPU 225. Using this approach helps with evenly distributing SAs to virtual CPUs 225.

In another example, the CPU selection function takes into account the number of in-bound SAs assigned to each virtual CPU. In such an example, IKE 251 maintains a count of in-bound SAs that are assigned to each virtual CPU. When a SA is assigned to a certain virtual CPU 225, IKE 251 increments the SA count (“SA count”) associated with the virtual CPU 225. The CPU selection function is, therefore, configured to select virtual CPUs 225 based on their corresponding SA counts. For example, the CPU selection function may be configured to select the virtual CPU with the lowest SA count. In certain embodiments, when two or more virtual CPUs 225 have the same lowest SA count, CPU selection function may be configured to use a round-robin approach in selecting the next virtual CPU. Using a function that takes into account the SA count associated with each of the virtual CPUs 225 is advantageous because SAs may be removed sometime after being assigned. For example, three SAs may be assigned to each of the four virtual CPUs 225. However, after a while, one or more of the three SAs assigned to one of the virtual CPUs 225 may be removed, in which case it is advantageous to assign the next upcoming SA to that virtual CPU, thereby distributing SAs among virtual CPUs 225 in a more even fashion.

In yet another example, the CPU selection function takes into account the CPU utilization of virtual CPUs 225. For example, the CPU selection function may be configured to select a virtual CPU based on the latest average CPU utilization of the virtual CPUs, such as by selecting the virtual CPU with the lowest CPU utilization. In one example, IKE 251 receives the CPU utilization information associated with virtual CPUs 225 from IPsec 252 (e.g., through a communication channel established between the two components). The CPU utilization information of a virtual CPU 225 may include average CPU utilization of the virtual CPU 225 over a defined period of time.

In some embodiments, a CPU selection function may take into account multiple factors, such as the number of in-bound SAs assigned to each virtual CPU, the CPU utilization of each virtual CPU, and/or additional factors.

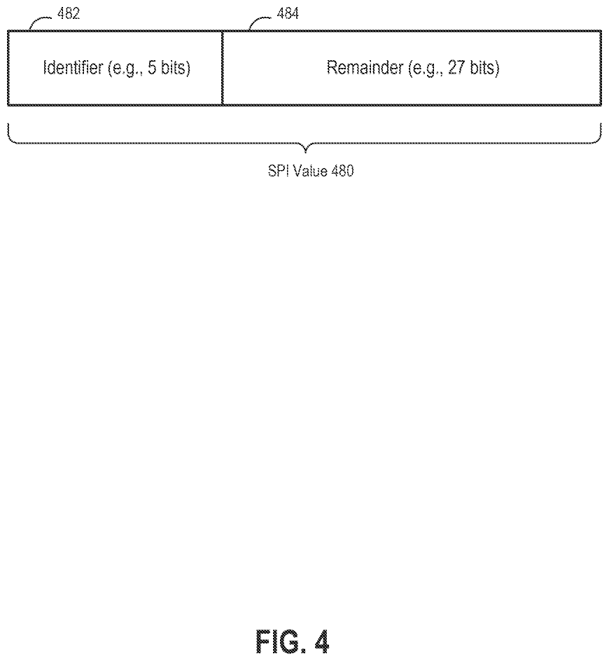

At block 330, TEP 125 generates an SPI value by including an identifier associated with an RSS queue associated with the virtual CPU, selected at block 320, in the SPI value. For example, IKE 251 generates an SPI value that includes an identifier associated with the RSS queue associated with the selected virtual CPU. FIG. 4 illustrates an example SPI value 480 including an identifier 482 (e.g., 5 bits) and a remainder 484 (e.g., 27 bits). As shown, identifier 482 makes up a portion of SPI value 480.

In one example, the identifier is an RSS queue number associated with an RSS queue, from RSS queues 227, that is associated with the selected virtual CPU. Including an RSS queue number in the SPI value helps ensure that the corresponding incoming packets, when received at TEP 125, are placed by VNIC 226 in the corresponding RSS queue 227 and are then processed by the selected virtual CPU 225. As described in further detail below, in some embodiments, VNIC 226 is configured with an ESP RSS mode, which enables VNIC 226 to examine and assign packets to different RSS queues 227 based on the identifiers in their corresponding SPI values.

In embodiments where the identifier is an RSS queue number, IKE 251 may be provided with access to or store a mapping of RSS queue numbers of RSS queues 227 to CPU core IDs of the virtual CPUs 225. This is to enable IKE 251 to identify the RSS queue 227 that is associated with the CPU core ID of the selected virtual CPU. In some embodiments, IPsec 252 provides this mapping to IKE 251. In certain embodiments, the mapping is an array where the array index numbers correspond to the CPU core IDs and the elements of the array indicate RSS queue numbers. As such, after selecting a virtual CPU 225 at block 320, IKE 251 refers to the mapping to identify the corresponding RSS queue number and then encodes the RSS queue number in the SPI value.

Encoding an RSS queue number into an SPI value may involve replacing n bits of the total number of bits in the SPI value with the n bits that represent the RSS queue number. For example, the IPsec standard calls for an SPI value being generated with 32 bits. In one embodiment, each RSS queue number may be 5 bits, which can specify up to 32 different RSS queues. In such an example, encoding an RSS queue number into the SPI value involves replacing 5 bits of the 32-bit SPI value with the 5 bits of the RSS queue number. The 5-bit RSS queue number may be inserted anywhere in the 32-bit SPI value and can be either non-contiguous or contiguous. The rest of the SPI value (e.g., the 27 bits) may include random bits. For efficient processing though, keeping the 5-bit RSS queue number contiguous is advantageous. Also, it may be more efficient to set the 5-bit RSS queue number at the most significant, or least significant bits of the SPI value. Note that the RSS queue number and the SPI value may have more or less than 5 bits and 32 bits, respectively, and that the number of bits used here are merely exemplary. Also note that encoding an RSS queue number into an SPI value may involve generating a number of random bits and then combining the random bits with the bits associated with the RSS queue number. For example, instead of generating a 32 bit SPI value and then replacing n bits with n bits of the RSS queue number, IKE 251 may generate 27 random bits and combine the n bits of the RSS queue number with those 27 random bits, thereby obtaining a 32 bit SPI value.

IKE 251 uses the generated SPI value, including the identifier, to establish an in-bound SA for communication between the source endpoint and destination endpoint (e.g., endpoint 110 and endpoint 120, respectively). The in-bound SA is used by IPsec 252 at TEP 125 to encrypt packets transmitted by endpoint 110 and destined for endpoint 120.

At block 340, TEP 125 indicates the SPI value generated at block 330 to TEP 115 for use in an in-bound SA utilized to encrypt data packets transmitted by the endpoint 110 and destined for VM 220(2). For example, IKE 251 indicates the generated SPI value to the peer IKE at TEP 115 for use in an in-bound SA utilized to encrypt data packets transmitted by endpoint 110 and destined for destination endpoint 120. After the SA is established with the generated SPI value, the IPsec component at TEP 115 encrypts any packets received from endpoint 110 and destined for endpoint 120 using the in-bound SA and the generated SPI value. Note that because TEP 125 independently generates the SPI value for use in incoming packets that are originated at endpoint 110 and encrypted by TEP 115, TEP 115 does not have to be aware or be able to determine that the SPI value includes an identifier associated with an RSS queue associated with a virtual CPU 225 at TEP 125. Additional information relating to SPI value generation may be found in Request for Comments (RFC) section 2409, the contents of which are incorporate herein in their entirety.

At block 350, TEP 125 receives an encrypted incoming packet from TEP 115. The encapsulated ESP encrypted incoming packet includes the SPI value generated at block 330. For example, VNIC 226 of TEP 125 receives the encapsulated ESP encrypted packet from TEP 115.

At block 360, TEP 125 processes the encapsulated ESP incoming encrypted packet using the selected virtual CPU based on the identifier that is encoded in the SPI value included in the packet. For example, after receiving the encapsulated ESP encrypted packet, VNIC 226 stores the packet in a certain RSS queue 227 based on the identifier in the SPI value of the packet. The identifier, as described above, may be an RSS queue number. A thread 229 at TEP 125 that is scheduled on the selected virtual CPU 225 then accesses the packet in the RSS queue 227, based on a mapping between RSS queue number 227 and virtual CPUs 225. In some embodiments, VNIC 226 is configured with an ESP RSS mode that is different from the existing RSS mode, which uses hashing to assign packets to RSS queues 227. The ESP RSS mode configures VNIC 226 to examine packets and determine if they are ESP encrypted. If yes, the ESP RSS mode further directs VNIC 226 to store the ESP encrypted packets in RSS queues 227 based on the identifiers included in the packets' SPI values.

In embodiments where IKE 251 is configured to encode RSS queue numbers into SPI values, the ESP RSS mode configures VNIC 226 to store each packet in an RSS queue 217 based on a corresponding RSS queue number in the packet's SPI value. If the ESP RSS mode determines that an incoming packet is not ESP encrypted, then the packet is passed by the ESP RSS mode to the existing RSS mode of VNIC 226 in order to assign the packet to an RSS queue 227 using a hashing function, as described above.

By utilizing the operations described above in relation to FIG. 3, IKE 251 is able to deterministically select a virtual CPU for processing encapsulated ESP encrypted packets associated with a certain in-bound SA (e.g., a certain pair of source and destination endpoints). This also ensures that encapsulated ESP encrypted packets from the same flow are not processed out of order because they all include the same SPI value in their headers and, therefore, are assigned to and processed by the same virtual CPU. Note that the computer architecture shown in FIG. 2 of the present disclosure is merely provided as an example and that operations 300 of FIG. 3 can be performed by a destination TEP that includes a physical computing device with physical CPUs.

If, however, IKE 251 is configured to use a new identifier, then IKE 251 undergoes operations 320-340 to select a virtual CPU, generate a new SPI value, including a new identifier associated with an RSS queue associated with the selected virtual CPU, and indicate the new SPI value to TEP 115. Note that even if IKE 251 is configured to generate a new identifier, the new identifier may still be the same as the previously used identifier because IKE 251 may select the same corresponding virtual CPU due to, for example, the virtual CPU having the lowest CPU utilization.

In some embodiments, instead of performing IKE with an IPsec peer when engaging in IPsec tunnel creation, IPsec 252 may receive an encryption/decryption key as well as an SPI value from a DNE controller (e.g., server 140). For example, the DNE controller may select a virtual CPU, generate an SPI value including an identifier associated with an RSS queue associated with the virtual CPU, as described above in relation to blocks 320-330 of FIG. 3, and subsequently transmit the SPI value to both TEP 125 and TEP 115 for use in establishing the in-bound SA utilized for encrypting packets transmitted from endpoint 110 to endpoint 120. In some embodiments, the DNE controller may have access to a CPU selection function as well as information that enables the DNE controller to select a virtual CPU. For example, the DNE controller may receive information about the level of load each virtual CPU of virtual CPUs 225 is handling or keep track of how many SAs are assigned to each virtual CPU at any point in time.

According to embodiments of the present disclosure, the IKE exchange during IPsec tunnel creation (e.g., at block 310 above) can include an exchange of an available number of cores at the IPsec peers. As discussed above, once the tunnel creation starts, the two IPsec peers, TEP 125 and TEP 115, begin the two-phase IKE process using their IKE components.

FIG. 5 illustrates an example IKE exchange 500 between an initiator (e.g., TEP 115) and a responder (e.g., TEP 125).

As shown, the IKE exchange 500 may include an IKE_SA_INIT request and response exchange at 502 and 504 respectively. This initial exchange establishes an IKE-SA before further exchanges occur and may be referred to as the phase 1 SA (or “parent” SA). In some embodiments, the IKE-SA comprises two one-way IKE-SAs—one IKE-SA for each direction. This initial exchange may include negotiation of security parameters for the IKE-SA, sending nonces, and/or sending of Diffie-Hellman values. In some embodiments, the IKE_SA_INIT request, at 502, includes an IKE header (HDR), a proposed SA (SAi1), a key exchange (KE), and a Notify (Ni). The HDR may include SPIs, version numbers, and flags. The SAi1 states the cryptographic algorithms the initiator supports for the IKE-SA. The KE sends the initiators Diffie-Helman value. The Ni is the initiator's nonce. In some embodiments, the IKE_SA_INIT response, at 504, includes the responders HDR, SAr1, Ker, Nr, and may optionally include a certificate request (CERTREQ). For example, the responder may choose a cryptographic suite from the initiator's offered choices and express that choice in the SAr1 payload, complete the Diffie-Hellman exchange with the KEr payload, and send its nonce in the Nr payload.

At this point in the negotiation, the responder and initiator can generate a seed (e.g., SKEYSEED), from which all keys are derived for the IKE-SA. The messages that follow are encrypted using the IKE-SA.

After establishing the IKE SA, the IKE exchange 500 may include an IKE_AUTH request and response exchange at 506 and 508 respectively. The IKE_AUTH request and response may exchange identities, prove knowledge of secrets related to those identities, and establish an IPsec SA (e.g., an AH and/or ESP SA) referred to as the phase 2 SA (or “child” SA).

In some embodiments, the IKE_AUTH request, at 506, includes HDR, an identification of the initiator (IDi), optionally a certificate (CERT), optionally a CERTREQ, optionally an identification of the responder (IDr), authentication (AUTH), a proposed child-SA (SAi2), a traffic selector of the initiator (TSi), and a traffic selector of the responder (TSr). The initiator asserts its identity with the Idi and proves knowledge of the secret corresponding to IDi and integrity protects the contents of the first message using the AUTH payload. Optionally, the initiator may send its certificate(s) in CERT payload(s) and a list of its trust anchors in CERTREQ payload(s). If any CERT payloads are included, the first certificate contains the public key used to verify the AUTH field. The optional IDr enables the initiator to specify to which of the responder's identities the initiator wants to talk. This is useful when the machine on which the responder is running is hosting multiple identities at the same IP address. The initiator begins negotiation of a child-SA using the SAi2 payload. The final fields (starting with SAi2) are described in the description of the CREATE_CHILD_SA exchange. TSi specifies the source address of traffic forwarded from (or the destination address of traffic forwarded to) the initiator and TSr specifies the destination address of the traffic forwarded to (or the source address of the traffic forwarded from) the responder. Each traffic selector consists of an address range. For example, TSi may specify the source subnet and TSr may specify the destination subnet.

As discussed herein, the IKE exchange includes an exchange of the available number of cores. In some embodiments, the number of available cores at the initiator (Ci) are included in the IKE_AUTH request at 506.

In some embodiments, the IKE_AUTH response, at 508, includes HDR, IDr, optionally a CERT, AUTH, a proposed child-SA (SAr2), TSi, and TSr. The responder asserts its identity with the IDr payload, optionally sends one or more certificates (again with the certificate containing the public key used to verify AUTH listed first), authenticates the responder's identity and protects the integrity of the second message with the AUTH payload, and completes negotiation of a child-SA.

As discussed herein, the IKE exchange includes an exchange of the available number of cores. In some embodiments, the number of available cores at the responder (Cr) are included in the IKE_AUTH response at 508.

According to embodiments of the present disclosure, IKE 251 splits the traffic selectors (TSi and TSr), exchanged at 506 and 508, into ranges that maximizes the number of SAs that can be negotiated and that maximizes the use of the available number of cores (Ci and Cr) exchange at 506 and 508. Additional CREATE_CHILD_SA message exchanges (510 and 512 below) are performed to create additional IPsec SAs for the datapath. Each IPsec SA is associated with a different SPI number. Accordingly, with knowledge of the number of available cores, more SAs can be negotiated and created, which enables load balancing to be used as described above with respect to FIG. 3.

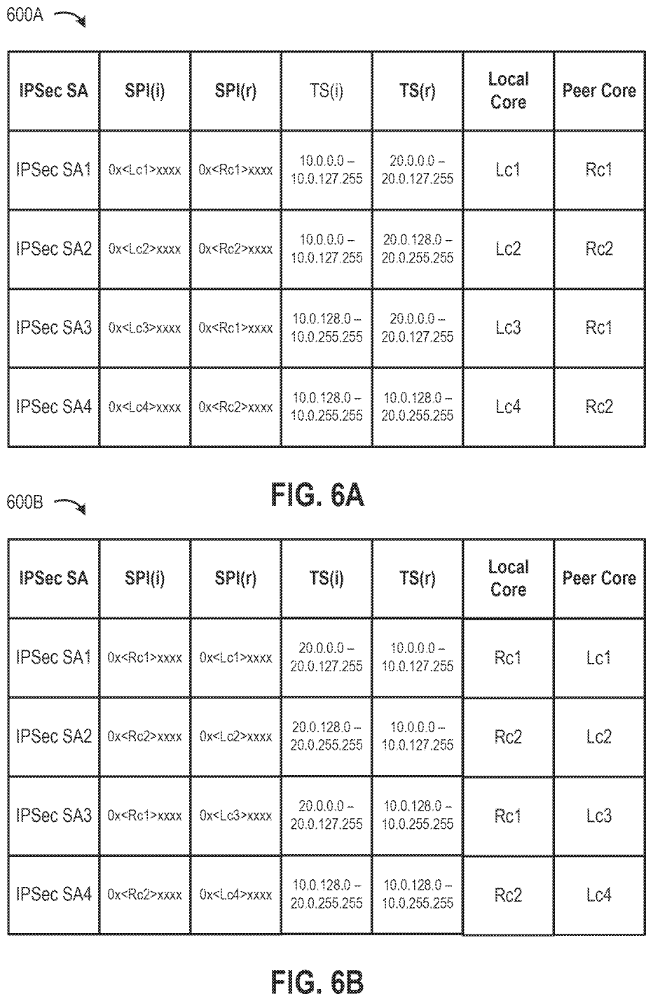

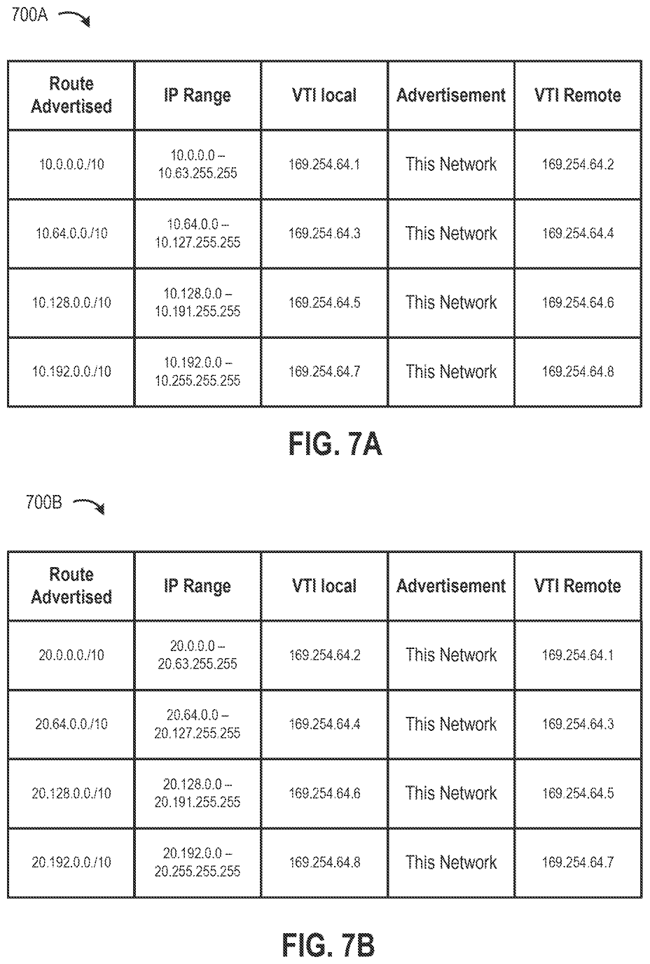

In some embodiments, the child SA established by the exchange of messages at 506 and 508 are used for a first combination of initiator and responder traffic selectors and a first combination of initiator and responder available cores, as discussed in more detail below with respect to the FIGS. 6A, 6B, 7A, and 7B.

After the initial IKE exchange and the authentication exchange, additional IPsec child-SAs can be established via the CREATE_CHILD_SA request and response exchanges, such as the message exchange at 510 and 512 respectively. The CREATE_CHILD_SA exchange is used to create new child-SAs, to rekey the IKE SA, and/or to rekey the first child-SA. In some embodiments, the additional exchanges after the initial IKE exchange and the authentication exchange are referred to as the Phase 2. It should be noted that either the initiator or responder of the initial IKE exchange may initiate a CREATE_CHILD_SA exchange. In some embodiments, the CREATE_CHILD_SA request includes HDR, SA, Ni, optionally KEi, TSi, and TSr. For example, the initiator may send SA offer(s) in the SA payload, a nonce in the Ni payload, optionally a Diffie-Hellman value in the KEi payload, and the proposed Traffic Selectors for the proposed child-SA in the TSi and TSr payloads.

In some embodiments, The CREATE_CHILD_SA response at 512 includes HDR, SA, Nr, KEr, TSi, and TSr. The responder replies with the accepted offer in an SA payload, and a Diffie-Hellman value in the KEr payload if KEi was included in the request and the selected cryptographic suite includes that group. The traffic selectors for traffic to be sent on that SA are specified in the TS payloads in the response, which may be a subset of what the initiator of the child-SA proposed.

In some embodiments, the child SA established by the exchange of messages at 510 and 512 are used for a second combination of the initiator and responder traffic selectors and a second combination of initiator and responder available cores, as discussed in more detail below with respect to the FIGS. 6A, 6B, 7A, and 7B.

An INFORMATIONAL request and response exchange at 514 and 516, respectively, may perform a variety of functions to maintain the SAs, such as deleting SAs, reporting error conditions, checking SA liveliness, or other SA housekeeping functions. It is noted that the CREATE_CHILD_SA and INFORMATION exchanges are optional and may be performed in any order.

Table 600A in FIG. 6A illustrates an example SA table for a local IPsec edge, according to some embodiments. Table 600B in FIG. 6B illustrates an example SA table for a peer IPsec edge, according to some embodiments. In the illustrative example, TSi=10.0.0.0/16, TSr=20.0.0.0/16, Ci=4, and Cr=2. In this example, IKE 251 splits the source subnet 10.0.0.0/16 and destination subnet 20.0.0.0/16 to ranges associated with four SAs, where the maximum available number of cores at the initiator and responder sides is four. For example, IKE 251 may divide TSi into the ranges 10.0.0.0-10.0.127.255 and 10.0.128.255-10.0.255.254 and TSr into the ranges 20.0.0.0-10.0.127.255; 20.0.128.255 and 20.0.255.254 as shown in tables 600A and 600B in FIGS. 6A-6B. One SA may be created for each combination of the TSi and TSr ranges. For example, SA1-SA4 are created, and each is associated with a combination of TSi and TSr ranges as shown in FIGS. 6A-6B. The SPIs (SPI(i) and SPI(r)) are then calculated for the SAs as shown in FIGS. 6A-6B. In some embodiments, the SPI is calculated such that an initial 5 bits of the SPI are reserved for the core number and the remaining 27 bits are reserved for randomness of SPI as shown in FIG. 4. Each SPI is associated with an initiator side core (e.g., Lc1, Lc2, Lc3, Lc4) and a responder side core (e.g., Rc1, Rc2) as shown in FIGS. 6A-6B. In some embodiments, the cores on the initiator side and responder side are assigned round-robin as shown in FIGS. 6A-6B.

Accordingly, the number of available cores (Ci and Cr exchanged at 506 and 508) may be used to determine the number of SAs to create, as described above. IKE 251 may determine number of SAs on-demand, even when the user has configured only a single source and destination subnet by default.

A route-based VPN may use a /27 subnet (i.e., subnet mask 255.255.255.224). Route-based VPN may use Border Gateway Protocol (BGP). Exterior BGP (eBGP) runs between two BGP routers in different autonomous systems (AS). In eBGP peers are assumed to be directly connected and will advertise learned routes. For eBGP, the local AS number (ASN) and remote ASN will block more ASN's. Interior BGP (iBGP) runs between two BGP routers within an AS. In iBGP, there is not restriction that neighbors have to be connected directly; however, an iBPG peer will not advertise learned routes to another iBGP peer. If using iBGP then the local ASN and remote ASN can be used. In some embodiments, the ASN is a private ASN (e.g., 65000) being used at both the peers.

In some embodiments, if there are multiple networks advertised, then based on the max (Ci, Cr), that number of BGP pairs can be established.

In some embodiments, for route-based VPNs, additional IPsec SA are established using the same virtual tunnel interface (VTI) interface or by adding support for multiple VTIs based on the number of available cores (e.g., Ci and Cr exchanged at 506 and 508). In some embodiments, to keep multiple IPsec SA's unique, an IPsec SA database (SAD) lookup may be performed in the datapath to have additional parameters (e.g., rule ID or core ID) in an IPsec hash map key to differentiate the traffic landing on a specific VTI interface and use the corresponding IPsec SA associated with a specific core for IPsec processing. For example, the rule or core ID may be added to the IPsec hash map, in addition to SPI, destination IP, virtual routing and forwarding ID (VRFID), protocol, and IP version parameters.

In some embodiments, a single VTI is used with multiple SAs. When a single VTI is used, multiple most significant bits (MSB) bits can be used to differentiate the inbound and outbound direction. For example, if four IPsec SAs (i.e. 4 inbound, 4 outbound) are established, three MSB bits in the rule id can be reserved and can be used to differentiate the SAs and the directions of the SAs. In some embodiments, multiple VTIs are used for the multiple SAs. When multiple VTI interfaces are used, the rule id calculation for inbound and outbound rules will be derived based on the MSB bit.

FIGS. 7A-7B illustrate example route advertisement tables 700A and 700B, respectively, for local and peer gateways over BGP respectively. For route-based VPN, the local subnet may be 0.0.0.0/0 and the peer subnet may be 0.0.0.0/0. The SA may be established with 0.0.0.0/0.0.0.0; however, it is the BGP route advertisement that routes the packets with the actual IPsec SA SPIs. In the example of Ci=4 and Cr=2 and four SAs, where TSi=10.0.0.0/10 and TSr=20.0.0.0/10, IKE 251 may split that traffic into four ranges and four routes may be advertisement by the local and peer gateways as shown in FIGS. 7A-7B.

The VTI interfaces can use IP addresses from a pool of subnets. In the illustrated example, local VTI subnet is 169.254.64.1/27 and the peer VTI subnet is 169.254.64.2/27. In this example, four VTI pairs are associated with the four SAs and the four advertised routes-169.254.64.1/27 and 169.254.64.2/27; 169.254.64.3 and 169.254.64.4; 169.254.64.5 and 169.254.64.6; and 169.254.64.7 and 169.254.64.8—as shown in FIGS. 7A-7B. Each pair of VTIs may be associated with a source side BGP and a peer side BGP.

It should be noted that the above example values for Ci and Cr are illustrative and the techniques above may be used for different numbers of available initiator and/or responder cores. Further, it should be noted that the above example subnets for TSi and TSr can be used for different subnets. In some embodiments, if the local gateway is advertising a 10.0.0.0/8 subnet and the peer gateway is advertising a 20.0.0.0/8 subnet, then 10.120.0.0/24 networks can also be split using the techniques described above in cases where there are no overlapping networks between source and destination VPN gateways.

In some embodiments, a firewall flow across the VTIs will be a shared pool of lookups.

In host machine 200, processing unit(s) may retrieve instructions to execute and data to process in order to execute the processes discussed herein. The processing unit(s) may be a single processor or a multi-core processor in different embodiments. The read-only-memory (ROM) may store static data and instructions that may be utilized by the processing unit(s) and other modules of the electronic system. The permanent storage device, on the other hand, may be a read-and-write memory device. The permanent storage device may be a non-volatile memory unit that stores instructions and data even when the host machine is off. Some embodiments use a mass-storage device (such as a magnetic or optical disk and its corresponding disk drive) as the permanent storage device.

Some embodiments use a removable storage device (such as a floppy disk, flash drive, etc.) as the permanent storage device. Like permanent storage device, the system memory may be a read-and-write memory device. However, unlike permanent storage device, the system memory may be a volatile read-and-write memory, such as a random access memory (RAM). The system memory may store some of the instructions and data that processing unit(s) utilize at runtime. In some embodiments, processes discussed herein are stored in the system memory, the permanent storage device, and/or the read-only memory.

Certain embodiments as described above involve a hardware abstraction layer on top of a host computer. The hardware abstraction layer allows multiple contexts or virtual computing instances to share the hardware resource. In some embodiments, these virtual computing instances are isolated from each other, each having at least a user application running therein. The hardware abstraction layer thus provides benefits of resource isolation and allocation among the virtual computing instances. In the foregoing embodiments, virtual machines are used as an example for the virtual computing instances and hypervisors as an example for the hardware abstraction layer. As described above, each virtual machine includes a guest operating system in which at least one application runs.

It should be noted that these embodiments may also apply to other examples of virtual computing instances, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest OS that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for tunnel creation according to a security protocol at a source tunnel endpoint (TEP), comprising:
exchanging first messages with a destination TEP to create a first security association (SA) for the tunnel creation;
sending a second message to the destination TEP, wherein the second message is an encrypted message based on the first message exchange, and wherein the second message includes a first traffic selector of the source TEP and a first number of available CPUs of the source TEP;
receiving a third message from the destination TEP, wherein the third message is an encrypted message based on the first message exchange, and wherein the third message includes a second traffic selector of the destination TEP and a second number of available CPUs of the destination TEP; and
determining a number of second one or more SAs to create with the destination TEP, wherein the determination is based on the first traffic selector, the second traffic selector, and a larger of the first number of available CPUs and the second number of available CPUs.

2. The method of claim 1, wherein the second message comprises an Internet Key Exchange (IKE) authentication request message, and the third message comprises an IKE authentication response message.

3. The method of claim 1, wherein:
the first traffic selector is associated with a first range of Internet Protocol (IP) addresses;
the second traffic selector is associated with a second range of IP addresses;
the method further comprises:
determining a number of subsets of the first range of IP address; and
determining the number of subsets of the second range of IP addresses; and
the number of subsets is equal to the larger of the first number of available CPUs and the second number of available CPUs.

4. The method of claim 3, further comprising, for each of the number of second one or more SAs:
selecting a CPU from the number of available CPUs of the destination TEP using a CPU selection function, the selected CPU being selected to process packets associated with the SA;
determining an identifier associated with a receive side scaling (RSS) queue associated with the selected CPU;
generating a security parameter index (SPI) value including the identifier associated with the RSS queue;
indicating the SPI value to the destination TEP; and
establishing the SA with the destination TEP using the SPI value.

5. The method of claim 4, wherein the CPU selection function uses a round-robin algorithm.

6. The method of claim 3, further comprising:
creating a number of virtual tunnel interface (VTI) pairs, wherein the number of VTI pairs is equal to the larger of the first number of available CPUs and the second number of available CPUs.

7. The method of claim 6, further comprising:
advertising one or more routes, wherein each route is associated with one of the subsets of the first range and with a VTI pair.

8. A system comprising:
one or more processors; and
at least one memory, the one or more processors and the at least one memory configured to:
exchange first messages, between a source tunnel endpoint (TEP) and a destination TEP to create a first security association (SA) for the tunnel creation;
send a second message, from the source TEP to the destination TEP, wherein the second message is an encrypted message based on the first message exchange, and wherein the second message includes a first traffic selector of the source TEP and a first number of available CPUs of the source TEP;
receive a third message, at the source TEP from the destination TEP, wherein the third message is an encrypted message based on the first message exchange, and wherein the third message includes a second traffic selector of the destination TEP and a second number of available CPUs of the destination TEP; and
determine, at the second TEP, a number of second one or more SAs to create with the destination TEP, wherein the determination is based on the first traffic selector, the second traffic selector, and a larger of the first number of available CPUs and the second number of available CPUs.

9. The system of claim 8, wherein the second message comprises an Internet Key Exchange (IKE) authentication request message, and the third message comprises an IKE authentication response message.

10. The system of claim 8, wherein:
the first traffic selector is associated with a first range of Internet Protocol (IP) addresses;
the second traffic selector is associated with a second range of IP addresses;
the one or more processors and the at least one memory are configured to:
determine a number of subsets of the first range of IP address; and
determine the number of subsets of the second range of IP addresses; and
the number of subsets is equal to the larger of the first number of available CPUs and the second number of available CPUs.

11. The system of claim 10, the one or more processors and the at least one memory configured to, for each of the number of second one or more SAs:
select a CPU from the number of available CPUs of the destination TEP using a CPU selection function, the selected CPU being selected to process packets associated with the SA;
determine an identifier associated with a receive side scaling (RSS) queue associated with the selected CPU;
generate a security parameter index (SPI) value including the identifier associated with the RSS queue;
indicate the SPI value to the destination TEP; and
establish the SA with the destination TEP using the SPI value.

12. The system of claim 11, wherein the CPU selection function uses a round-robin algorithm.

13. The system of claim 10, e one or more processors and the at least one memory configured to:
create a number of virtual tunnel interface (VTI) pairs, wherein the number of VTI pairs is equal to the larger of the first number of available CPUs and the second number of available CPUs.

14. A non-transitory computer-readable medium comprising instructions that, when executed by one or more processors of a computing system, cause the computing system to perform operations for tunnel creation according to a security protocol at a source tunnel endpoint (TEP), the operations comprising:
exchanging first messages with a destination TEP to create a first security association (SA) for the tunnel creation;
sending a second message to the destination TEP, wherein the second message is an encrypted message based on the first message exchange, and wherein the second message includes a first traffic selector of the source TEP and a first number of available CPUs of the source TEP;
receiving a third message from the destination TEP, wherein the third message is an encrypted message based on the first message exchange, and wherein the third message includes a second traffic selector of the destination TEP and a second number of available CPUs of the destination TEP; and
determining a number of second one or more SAs to create with the destination TEP, wherein the determination is based on the first traffic selector, the second traffic selector, and a larger of the first number of available CPUs and the second number of available CPUs.

15. The non-transitory computer-readable medium of claim 14, wherein the second message comprises an Internet Key Exchange (IKE) authentication request message, and the third message comprises an IKE authentication response message.

16. The non-transitory computer-readable medium of claim 14, wherein:
the first traffic selector is associated with a first range of Internet Protocol (IP) addresses;
the second traffic selector is associated with a second range of IP addresses;
the operations further comprises:
determining a number of subsets of the first range of IP address; and
determining the number of subsets of the second range of IP addresses; and
the number of subsets is equal to the larger of the first number of available CPUs and the second number of available CPUs.

17. The non-transitory computer-readable medium of claim 16, the operations further comprising, for each of the number of second one or more SAs:
selecting a CPU from the number of available CPUs of the destination TEP using a CPU selection function, the selected CPU being selected to process packets associated with the SA;
determining an identifier associated with a receive side scaling (RSS) queue associated with the selected CPU;
generating a security parameter index (SPI) value including the identifier associated with the RSS queue;
indicating the SPI value to the destination TEP; and
establishing the SA with the destination TEP using the SPI value.

18. The non-transitory computer-readable medium of claim 17, wherein the CPU selection function uses a round-robin algorithm.

19. The non-transitory computer-readable medium of claim 16, the operations further comprising:
creating a number of virtual tunnel interface (VTI) pairs, wherein the number of VTI pairs is equal to the larger of the first number of available CPUs and the second number of available CPUs.

20. The non-transitory computer-readable medium of claim 19, the operations further comprising:
advertising one or more routes, wherein each route is associated with one of the subsets of the first range and with a VTI pair.
